(19) United States
(12) Patent Application Publication
(10) Pub. No.: US 2002/0157470 A1
(43) Pub. Date: Oct. 31, 2002

(54) Device for measuring bearing data

(76) Inventors: Jens Noetzel, Bremen (DE); Josef Binder, Worpswede (DE); Oliver Ahrens, Bremen (DE); Andreas Buhrdorf, Bremen (DE); Christian Stehning, Bremen (DE); Dennis Hohlfeld, Syke (DE); Rainer Breitenbach, Gochsheim (DE); Jens Heim, Schweinfurt (DE); Heinrich Hofmann, Schweinfurt (DE); Roland Werb, Riedbach (DE); Vasilis Hassiotis, Niederwerrn (DE)

Correspondence Address: OSTROLENK FABER GERB & SOFFEN, 1180 AVENUE OF THE AMERICAS, NEW YORK, NY, 100368403

(21) Appl. No.: 09/562,981

(22) Filed: Apr. 27, 2000

(30) Foreign Application Priority Data
Apr. 27, 1999 (DE) 199 19 006.2

(51) Int. Cl. G01N 29/04; G01N 24/00

(52) U.S. Cl. 73/593; 73/597; 384/488

(57) ABSTRACT

To make available to the vehicle control systems more information on the forces and directions of the forces which act on the individual tires, in order to determine these forces, the displacements between the outer ring and inner ring in the wheel bearings are measured in a contactless fashion using ultrasound. Displacements are measured by one or more sets of an ultrasound transmitter and a receiver on the stationary ring and a reflection surface on the rotating ring for reflecting back the ultrasound energy. The measured time until the signal is received enables displacement to be determined. It is possible to use these displacements to calculate the forces acting from a knowledge of the spring characteristic of the wheel bearings.

### FIELD OF THE INVENTION

The invention relates to a device for measuring load data of a bearing, preferably in a wheel bearing.

### BACKGROUND OF THE INVENTION

To further improve the driving comfort and safety of modern vehicles, electronic control systems for driving operation in the vehicles increasingly require more information on the current driving situation. In addition to the currently obtainable data for the engine, the transmission and the speed of the individual wheels, a future objective is also to use the current forces and directions of forces which act on the individual vehicle tires in order to control the driving operation. To detect these forces, it is obvious to make measurements at the wheel bearings, since they transmit all the forces acting on the tire onto the frame of the vehicle. The forces which are transmitted from the tire onto the vehicle frame cause displacements in the wheel bearing and particularly tilting between the inner ring and outer ring. Measurements of displacements between the inner and outer rings in the wheel bearing can be used together with knowledge of the special spring characteristic of the individual bearing to draw direct conclusions about the forces acting.

EP 0530093 B1 discloses magnetic distance meters which can measure the displacements in a rolling bearing in a specific direction. However, these magnetic distance meters can measure only on a displacement axis. The accuracy of the measurement obtained is only in the range of 1/100 mm. This measurement accuracy is not sufficient to measure relatively small displacements in the rolling bearing as well, and thus is not able to control the vehicle with sufficient accuracy in individual driving situations.

### SUMMARY OF THE INVENTION

The object of the invention is to provide a measuring system which measures more accurately and simultaneously measures all displacements between the rotating, usually inner, ring and the stationary, usually outer, ring in a bearing.

This object is achieved according to the invention by use of a known distance measuring method using ultrasound applied to a bearing. High measuring accuracy of 0.5/1000 mm is achieved by using ultrasonic measuring units which operate at a frequency higher than 100 kilohertz. The ultrasonic transmitter and the ultrasonic receiver are arranged on the stationary raceway of the bearing or in the housing. A reflection surface provided on the rotating raceway reflects the ultrasonic beams from the ultrasonic transmitter to the ultrasonic receiver. The difference or change in distance is then determined via the phase difference between a reference signal and the received ultrasonic signal. The reference signal which is used in the evaluation electronic system is identical to the transmitted signal and is used to calculate the phase difference. An absolute measurement of the distance between the stationary and rotating raceways is performed by measuring the propagation time of the received signal.

One special form of ultrasonic distance measurement via the phase difference is the known method of ultrasound resonance mode locking. In this case, the resonant frequency (standing wave between ultrasonic transmitter and reference surface) is determined. This corresponds to a phase difference of 0° or 360° between the transmitted and received waves. This resonant frequency is directly proportional to the distance between the ultrasonic transmitter and reference surface. In one method, the ultrasonic frequency is slaved to the current variation in distance such that the phase difference remains constant at 0° or 360°.

Another method comprises determining the impedance with a standing wave in the case of an ultrasonic transmitter or ultrasonic transducer (phase angle between the drive current and drive voltage in the ultrasonic transducer). This phase angle is controlled back again to the initial value by varying the ultrasonic transmitting frequency in the event of a variation in distance. No separate ultrasonic receiver is required with this method.

A plurality of ultrasonic measuring units can be fitted in a bearing in order to measure the displacements with those units. Owing to the radial arrangement of the measuring units in, for example, the horizontal or vertical direction of a measuring plane, all the radial displacements can be measured directly. A radial arrangement of the measuring units, offset by 180° in angular position, yields yet more accurate results, because of the differential measurements in this direction of the action of force.

A trapezoidal (rectangular, in a special case) ring may be arranged on the rotating raceway. In addition to the radial displacements, this rectangular ring makes it possible to measure axial displacements in the rolling bearing. It is therefore possible to measure all the displacements in a rolling bearing. Owing to the design of this ring in the form of a trapezoid, the surface which is not perpendicular to the raceway can be designed with an angle such that it is therefore possible to measure a specific combination of radial and axial displacements directly.

The ultrasonic measuring units are located between two sealing devices. This is required so that the measurement result of the ultrasonic measuring units is not influenced by contaminants which penetrate into the rolling bearing from outside, nor by lubricants or abraded matter coming from the rolling bearing.

The temperature of the measuring section can be determined directly via the propagation time shift in the ultrasonic signal for a given difference in propagation distance. The physical relationship is to be gathered from the following formula:

$$T = \frac{1}{R \cdot χ} \cdot {( \frac{Δ h}{Δ t} )}^{2}$$

T=temperature; R=specific gas constant, χ=isentropic exponent; Δh=distance between cutout and elevation, Δt=time shift.

The introduction of defined elevations and cutouts into the reference surface of the rotating raceway can be used to draw a direct conclusion on the temperature in the bearing via the time of the absence of an ultrasonic signal at the receiver upon transition from the elevation into the cutout Δt_{A}, or from the period of the superimposed signal during transition from the cutout onto the elevation Δt_{B}.

A further advantage of the elevations and cutouts is that it is thereby simultaneously possible to detect the speed and the direction of rotation of the rotating raceway, that is of the wheel.

For detecting the direction of rotation, three successive elevations or cutouts of increasing width are constructed. This known method for detecting the direction of rotation is described in DE-A 3733136.

An ultrasonic measuring unit may be used in conjunction with defined cutouts and elevations on the reflection surface to determine the distance or variation in distance between the stationary ring and the rotating ring, the speed and direction of rotation of the rotating ring and the temperature of the measuring section.

### BRIEF DESCRIPTION OF THE DRAWINGS

Other objects and features of the invention are explained in more detail with reference to the drawings, in which:

FIGS. 1A and 1B show the principle of the design of the measuring device using the phase comparison method, with FIG. 1A showing the bearing unloaded and FIG. 1B showing the bearing loaded, FIG. 2 shows the forces and/or torques acting in the wheel bearing,

FIG. 3 shows in a greatly enlarged manner the displacements in the rolling bearing resulting therefrom,

FIG. 4 shows the ultrasonic measuring device in a rolling bearing with exchange of energy and data by telemetry,

FIG. 5 shows the ultrasonic measuring device in a wheel bearing with exchange of energy and data via cable,

FIGS. 6a, 6b, 6c and 6d show various arrangements for measuring radial displacements in the bearing,

FIG. 7 shows the mode of operation of the ultrasonic measuring device on the cutouts or elevations in the reference surface, and

FIG. 8 shows a combination of a sealing disk and a perforated plate.

### DETAILED DESCRIPTION OF THE PREFERRED EMBODIMENTS

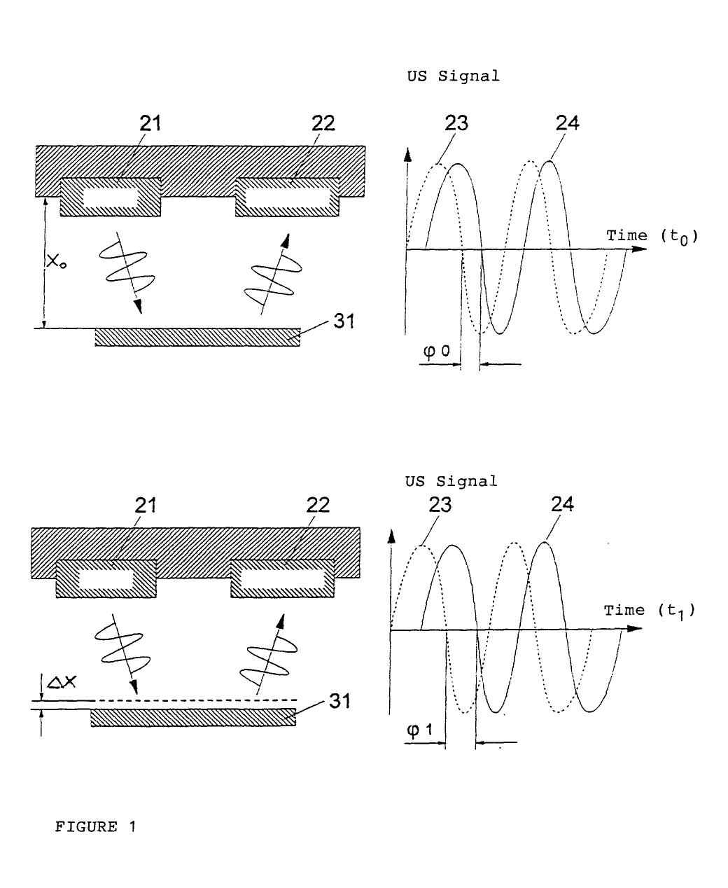

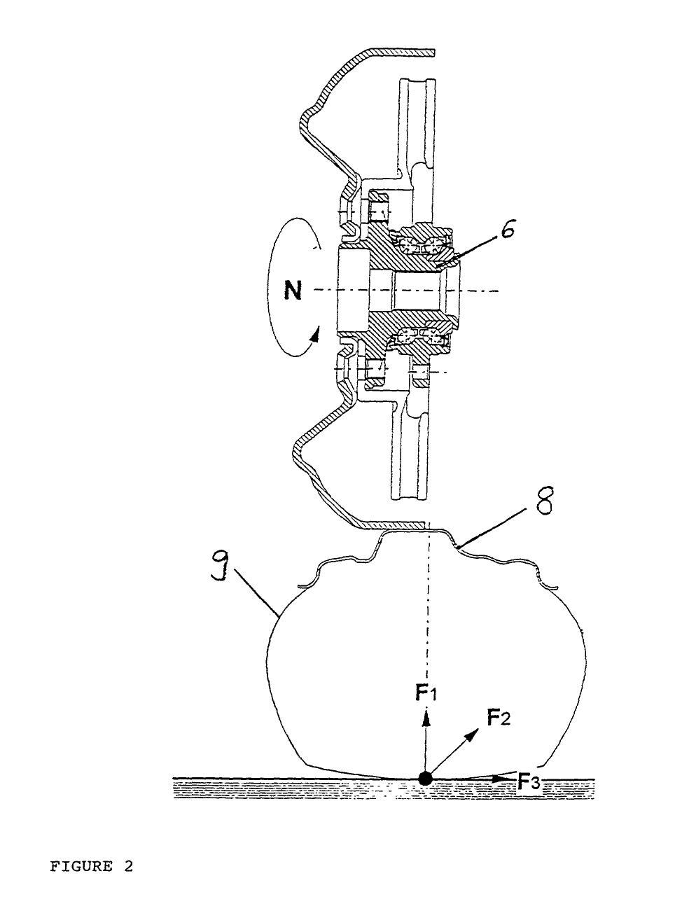

FIG. 1 shows the fundamental measuring principle for measuring load data of a bearing, with the aid of several illustrations. An ultrasonic transmitter 21 emits acoustic waves in the frequency range of >100 kilohertz, which are reflected at the surface 31 and picked up by the receiver 22 producing a received signal. In the unloaded position of the bearing in FIG. 1A, for a distance x₀ between the outer ring and the inner ring, the result is a phase angle φ₀ between the reference signal 23 and the received signal 24. The reference signal 23 is a signal from the controller which is identical to the transmitted signal.

Loading of the bearing with external forces, as shown in FIG. 1B, has the effect that the rotating ring of the bearing is displaced by Δx in comparison with the stationary ring of the bearing, and this also displaces the phase angle of the received signal 24. The received signal 24 now has a phase angle φ₁ in comparison with the reference signal 23. Thus, the resulting phase shift Δφ, is

Δφ=φ₁−φ₀

which is proportional to the displacement of the bearing and therefore proportional to the forces acting from outside.

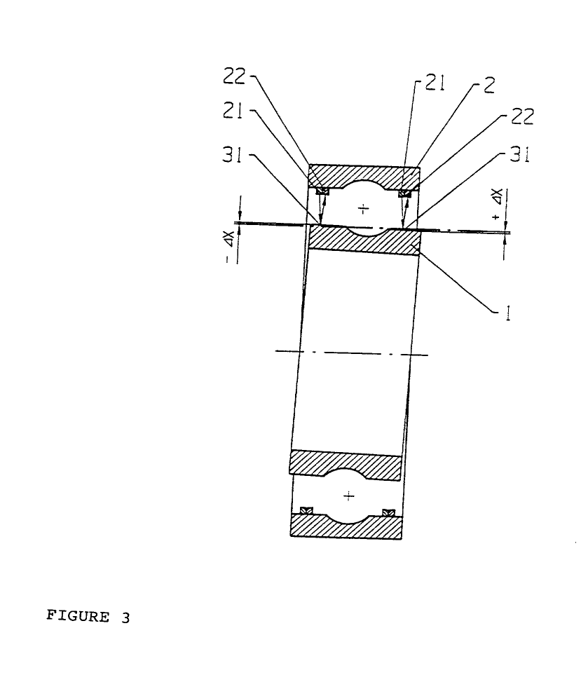

FIG. 2 shows the vectors of forces F₁, F₂, F₃ acting on the tire 9. These forces are transmitted onto the inner ring 1 via the wheel rim 8 and the wheel bearing flange 6. These forces and/or torques now cause displacements and tilts in the wheel bearing between the stationary outer ring 2 and the rotating inner ring 1 (see FIG. 3). These displacements are then converted back into acting forces based on knowledge of the spring characteristic of the wheel bearing, the wheel bearing flange 6, the rim 8 and the tire 9 as well as their geometric relationships.

The tilt between the inner ring 1 and the outer ring 2 is shown in FIG. 3. Here, +/−Δx is the measured displacement in the bearing. Ultrasonic measuring units 21, 22, 31 are arranged in this case on both sides of the bearing.

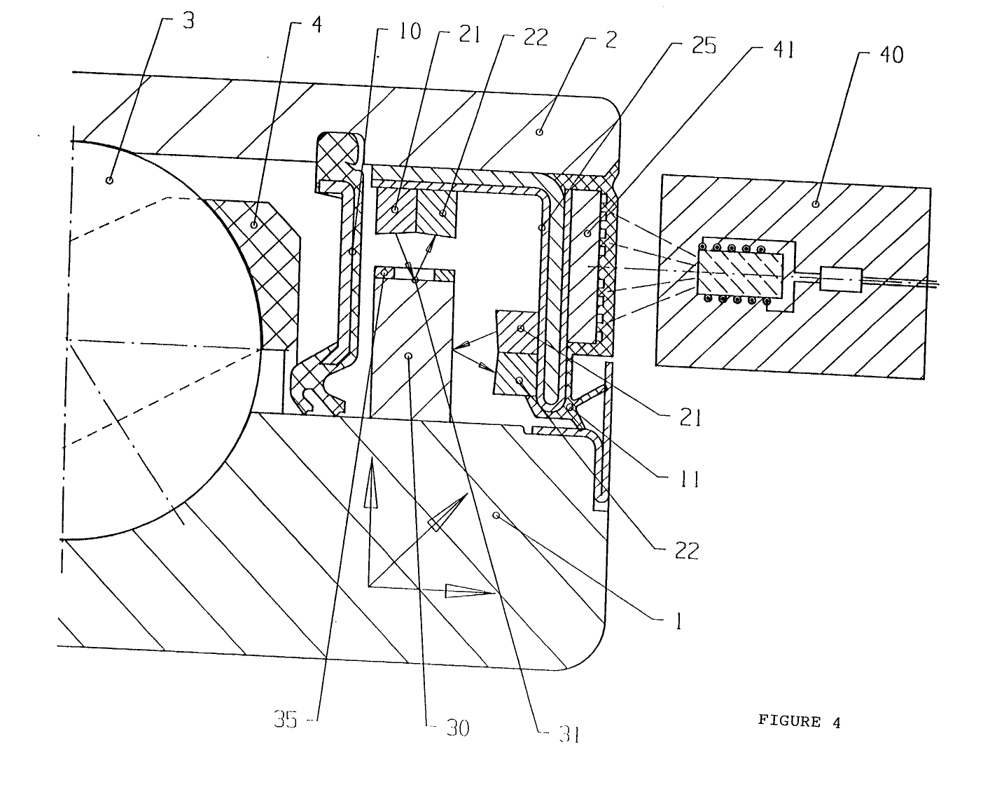

FIG. 4 shows the lateral sealing region of a rolling bearing. The ultrasonic measuring devices are located laterally between the seals 10, 11 and the seals are on the opposite axial sides of the devices to protect the devices against contamination from either inside or outside the bearing. The devices are also arranged radially between the stationary outer ring 2 and the rotating inner ring 1. The devices are also disposed on the legs of the L-shaped seal 11. That seal is attached to the outer ring 2 and is therefore stationary with respect to rotation of the inner ring 1. The ultrasonic transmitters 21 at both legs of the seal 11 emit sound waves in the direction of the rectangular reflection box 30. The signal is reflected at respective opposing reflection surfaces 31 of the reflection box and arrives at the respective ultrasonic receivers 22.

The measured signals are then transmitted to a central processor 41 via flexible conductor tracks 25 on the seal. The central processor transmits the protocol, which contains the bearing information to be transmitted, to the telemetric transmitting and receiving unit 40. The central processor 41 is supplied with energy in this example by telemetry via the transmitter 40. Shown in a radial orientation on the rectangular reference surface 30 is a ring with cutouts 35. In addition to the displacements, the cutouts enable the speed, the direction of rotation and the temperature of the bearing air are also determined.

FIG. 5 shows an arrangement of the ultrasonic measuring unit located between two rows of balls in a wheel bearing. Each row has a respective inner ring 1 and outer ring 2. The outer rings 2 are stationary, while both inner rings 1, which are fastened to the wheel bearing flange 6, rotate. The ultrasonic measuring units are arranged laterally between the two bearing seals 12 which protect the units against contamination. The ultrasonic transmitter 21 emits sound waves in the direction of the rectangular reflection box 30. The signal is reflected at the reflection surface 31 of the reflection box, and arrives at the ultrasonic receiver 22. The measured signals are conducted to the external data evaluation device via flexible conductor tracks 25. The units are supplied with power via cables from outside the unit. Shown on the reflection box 30 in a radial orientation is the ring with cutouts 35 via which, in addition to enabling determination of the displacements, enables the speed, the direction of rotation and the temperature of the measuring section to also be determined.

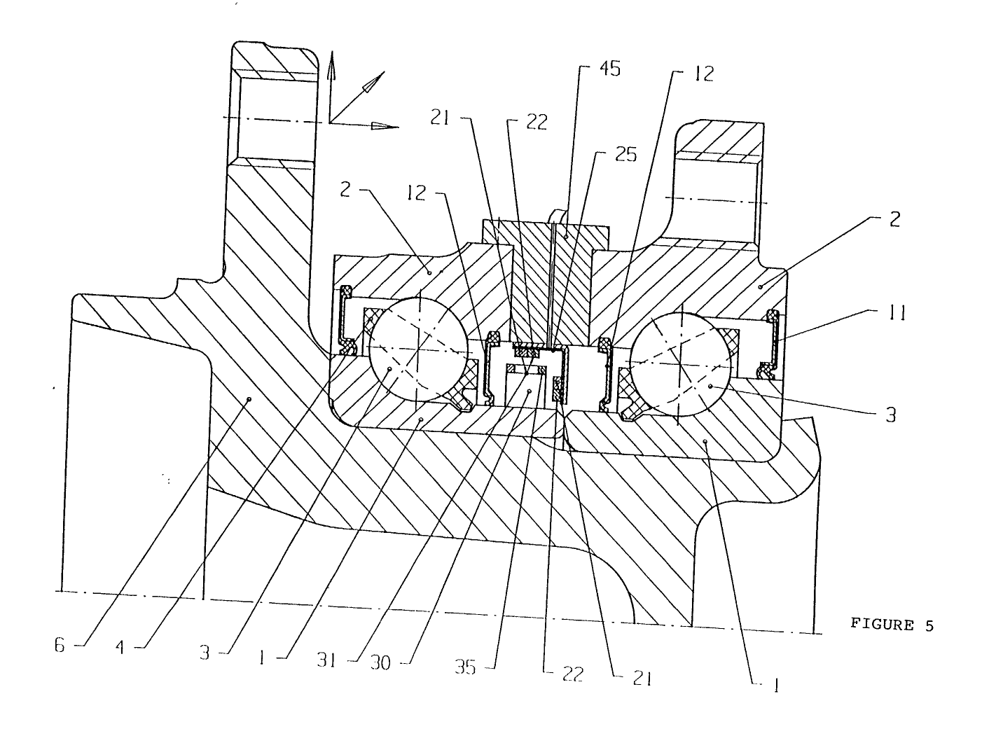

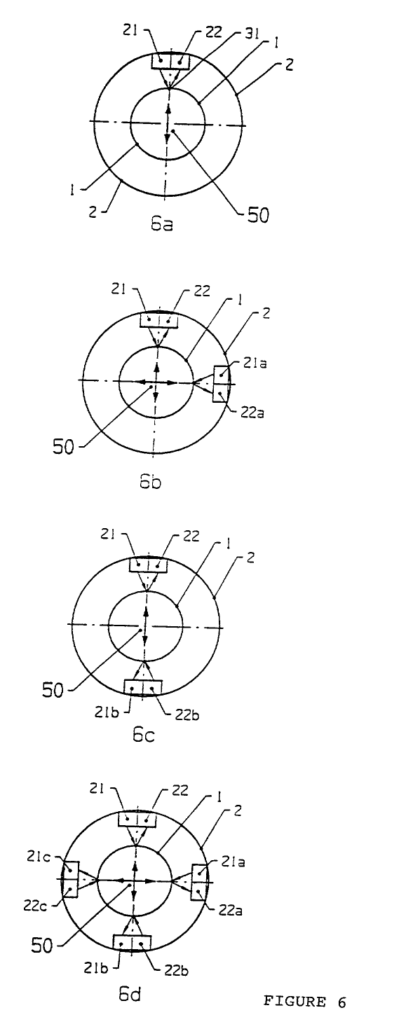

FIG. 6a-d show the angular positions of the individual ultrasonic measuring units in a bearing in radial arrangement in a measuring plane. The inner ring 1 rotates, and the outer ring 2 is stationary. The arrows 50 show those directions of force and/or displacements which can be measured directly by the ultrasonic measuring units. In FIG. 6a, an ultrasonic measuring unit (21, 22, 31) is arranged such that the displacement in only one direction can be measured. The additional arrangement of the ultrasonic measuring units (21, 22, 31, 21a, 22a), offset by 90° as in FIG. 6b, enable all the displacements in a plane to be determined. Differential measurement in one direction is shown in FIG. 6c. The ultrasonic measuring units (21, 22, 31, 21b, 22b) are in this case offset by 180°. Measuring inaccuracies are reduced by the differential formation of two measuring signals. Such differential formation is described in FIG. 6d for two measuring directions. All the displacements in this plane are therefore measured more accurately.

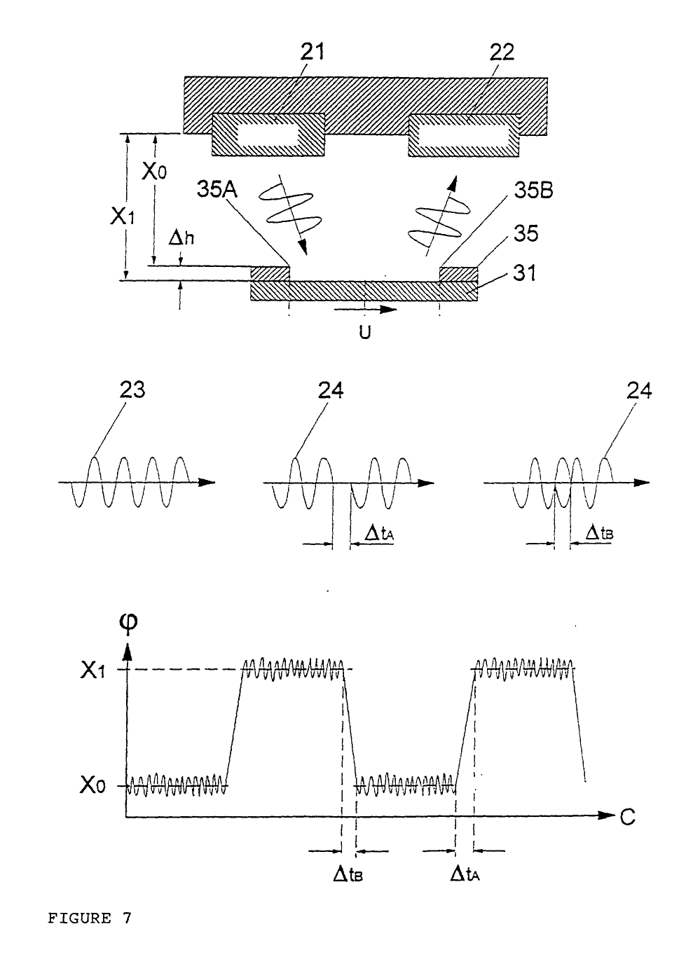

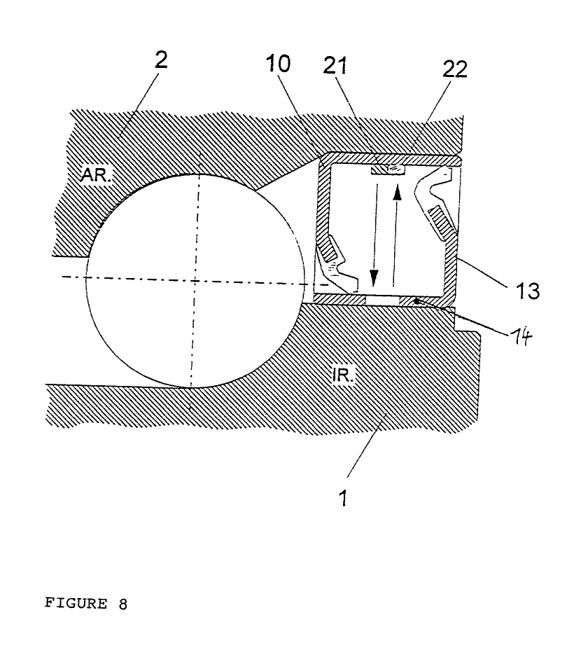

An ultrasonic unit with a signal characteristic at the cutouts and elevations 35 in the reflection surface is shown in FIG. 7. The reference signal 23 is compared with the received signal 24. Upon transition from the elevation into the cutout, no signal is received for a time Δt_{A} because of the known longer propagation distance. Upon transition from the cutout onto the elevation, a superimposed signal is received for the period Δt_{B}. On the basis of the temperature-dependent rate of propagation of the ultrasonic waves in air, differences in propagation distance thus known are used for the purpose of determining the temperature of the measuring section. Δt_{A} and Δt_{B} are thus in a known relationship with the temperature of the air in the bearing in accordance with the above noted formula.

FIG. 8 shows the sealing region of a rolling bearing between the seals 10 and 13. The ultrasonic transmitter 21 and ultrasonic receiver 22 are fitted to the stationary outer ring 2 between the radial legs of the seals. The reflection surface for the ultrasonic signal is in the limb 14 of the seal 13. The cutouts for detecting speed are integrated in this region of the seal 13.

Although the present invention has been described in relation to a particular embodiment thereof, many other variations and modifications and other uses will become apparent to those skilled in the art. It is preferred, therefore, that the present invention be limited not by the specific disclosure herein, but only by the appended claims.

In the claims:

1. A device for measuring small displacements between the stationary and rotating rings of a bearing, the device comprising:
a sensor for being fitted to a stationary raceway or a housing of the bearing,
a reflection surface arranged on a rotating raceway or shaft of the bearing,
a measuring unit comprising at least one stationary ultrasonic energy transmitting unit and a respective at least one ultrasonic receiving unit on the stationary raceway or the housing, the reflection surface being arranged between the transmitting and receiving units and on the rotating raceway for reflecting the ultrasonic energy from the transmitting unit to the receiving unit;
the measuring unit being adapted to determine the variation in distance via the phase difference or the resonance mode locking or the propagation time between the received signal and a reference signal, which is equivalent to the transmitted signal.

2. The device for measuring bearing displacement as claimed in claim 1, wherein a plurality of the measuring units are fitted at various angular positions with reference to the rotation axis of the bearing for measuring various radial displacements.

3. The device in claim 2 wherein the measuring units are in a plane through the axis of the bearing.

4. The device for measuring bearing displacement as claimed in claim 2, wherein the reflection surface has the form of a ring of trapezoidal cross section and is adapted to be fastened to the rotating raceway of the bearing such that radial and axial displacements can be measured.

5. The device for measuring bearing displacement as claimed in claim 1, wherein the reflection surface has the form of a ring of trapezoidal cross section and is adapted to be fastened to the rotating raceway of the bearing such that radial and axial displacements can be measured.

6. The device for measuring bearing displacement as claimed in claim 1, further comprising sealing devices on axial sides of the measuring units for protecting the measuring units on both sides against contaminants or lubricant so that the distance measurement is not influenced by contaminants.

7. The device for measuring bearing displacement as claimed in claim 1, wherein the reflection surface comprises defined elevations and cutouts arranged around in the circumferential direction such that a direct conclusion can be drawn on the temperature of the measuring section and thus of the air in the bearing via the propagation time difference (Δt_{A}, Δt_{B}) of the ultrasonic signal between the transition from the elevation to the cutout, and vice versa.

8. A device for using ultrasound for measuring the distance or variation in distance between a stationary raceway or housing and a rotating raceway or shaft in a bearing, comprising
a) at least one ultrasonic transmitting unit disposed on the stationary raceway or housing and which transmits ultrasonic energy at a frequency of greater than 100 kilohertz, p1 b) a reflection surface on the rotating raceway of the bearing,
c) at least one receiving unit on the stationary raceway or housing and which receives the ultrasound reflected from the reflection surface; and
d) an evaluating electronic system for determining the variation in distance or the distance based on the phase difference, or resonance mode locking or propagation time between the reference signal and the received signal.

9. A bearing including:
a housing;
a bearing outer ring at the housing and having a stationary raceway;
a bearing inner ring inward of the outer ring and having a rotating raceway;
bearing rolling elements between and engaging the outer and inner rings; and
a device for measuring small displacements between the stationary rotating rings of the bearing, the device comprising:
a sensor for being fitted to the stationary raceway or the housing of the bearing,
a reflection surface arranged on the rotating raceway of the bearing,
a measuring unit comprising at least one stationary ultrasonic energy transmitting unit, and a respective at least one ultrasonic receiving unit located on the stationary raceway or the housing, the reflection surface being arranged between the transmitting and receiving units and on the rotating raceway for reflecting the ultrasonic energy from the transmitting unit to the receiving unit;
the measuring unit being adapted to determine the variation in distance via the phase difference or the resonance mode locking or the propagation time between the received signal and a reference signal, which is equivalent to the transmitted signal.

10. The bearing of claim 8, further comprising sealing devices on axial sides of the measuring units for protecting the measuring units on both sides against contaminants or lubricant so that the distance measurement is not influenced by contaminants.

11. The bearing of claim 8, wherein the reflection surface is defined elevations and cutouts arranged around in the circumferential direction such that a direct conclusion can be drawn on the temperature of the measuring section and thus of the air in the bearing via the propagation time difference (Δt_{A}, Δt_{B}) of the ultrasonic signal between the transition from the elevation to the cutout, and vice versa.
